(19) United States
(12) Patent Application Publication
(10) Pub. No.: US 2008/0308341 A1
(43) Pub. Date: Dec. 18, 2008

(54) Vehicle Steering System and Method for Controlling a Vehicle Steering System

(75) Inventors: Steffen Linkenbach, Eschborn (DE); Johann Jungbecker, Badenheim (DE)

Correspondence Address: CONTINENTAL TEVES, INC., ONE CONTINENTAL DRIVE, AUBURN HILLLS, MI, 48326-1581, US

(73) Assignee: Continental Teves AG & Co. OHG, Frankfurt Am Main (DE)

(21) Appl. No.: 11/794,387

(22) PCT Filed: Dec. 16, 2005
(86) PCT No.: PCT/EP2005/056853

§ 371 Date: Apr. 2, 2008

(30) Foreign Application Priority Data
Dec. 27, 2004 (DE) 10 2004 062 730.4
Nov. 23, 2005 (DE) 10 2005 056 167.5

(51) Int. Cl. B62D 5/09

(52) U.S. Cl. 180/441

(57) ABSTRACT

The invention discloses a vehicle steering system for motor vehicles with a steering handle operable by the driver and connected to steerable vehicle wheels in terms of effect in order to determine a direction of driving. The vehicle steering system comprises a hydraulic steering cylinder having two directions of effect, as well as a hydraulic pressure source, which applies hydraulic pressure to a steering valve. The steering valve controls the magnitude of the hydraulic pressure conveyed to the steering cylinder and determines the direction of effect of the steering cylinder. The steering valve is an electromotively driven slide valve. The steering valve comprises a rotation-translation gear in order to displace a control slide of the steering valve in a translational way.

The present invention relates to a vehicle steering system and a method of controlling a vehicle steering system.

Up-to-date motor vehicles, especially passenger vehicles, are generally equipped with hydraulic or electrohydraulic power steering systems, in which a steering wheel is compulsorily coupled mechanically to the steerable vehicle wheels. The servo aid of the vehicle steering system usually includes one or more actuators such as hydraulic cylinders in the mid-portion of the steering mechanism. A force generated by the actuators supports the operation of the steering mechanism as a reaction to the rotation of the steering wheel induced by the driver. This reduces the expenditure of force of the driver during the steering operation.

Hydraulic vehicle steering systems known in the art are hydraulic power steering systems according to the open-center principle wherein, in the straight-ahead position of the steering wheel, substantially no pressure difference prevails between the cylinder chambers of a hydraulic steering cylinder being separated by a piston. In steering systems of this type, a corresponding servo pressure is adjusted by means of mechanical coupling of the steering column with the steering valve and is delivered to a cylinder chamber of the steering cylinder, in order to produce the desired steering boost. Due to the mechanical coupling of the steering valve with the torsion rod, it is not possible to take influence on the steering valve because any influence would have a reaction to the steering wheel and irritate the driver.

An object of the invention involves providing a vehicle steering system of the mentioned type, which allows taking influence on the steering valve beyond the usual degree.

This object is achieved by a vehicle steering system according to claim 1. In particular, the invention discloses a vehicle steering system for motor vehicles with a steering handle operable by the driver and connected to steerable vehicle wheels in terms of effect to determine a direction of driving. The vehicle steering system comprises a hydraulic steering cylinder having two directions of effect, and a hydraulic pressure source, which applies hydraulic pressure to a steering valve. The steering valve controls the magnitude of the hydraulic pressure conveyed to the steering cylinder and determines the direction of effect of the steering cylinder. According to the invention, the steering valve is an electromotively driven slide valve. The steering valve comprises a rotation-translation gear in order to displace a control slide of the steering valve in a translational way.

In a preferred embodiment of the invention, the rotation-translation gear is spring-centered, and it resets itself into its zero position in the absence of an external drive.

In an improvement of the vehicle steering system, the steering valve includes a control piston and a control sleeve, which forms a hydraulic full bridge with concealed control edges. In this case, the control sleeve of the steering valve can exhibit round or parallelogram-shaped control windows.

In an expedient embodiment of the invention, a valve is provided, which establishes a hydraulic short-circuit between the cylinder chambers of the steering cylinder in the event of current failure. The valve can be a hydraulically controllable seat valve, which is driven by the pressure of the pressure source and a control valve.

In an improvement of the vehicle steering system, there is provision of two safety valves, which are configured as seat valves and connect the cylinder chambers of the steering cylinder to an unpressurized supply reservoir in terms of flow when current failure occurs.

Advantageously, both control valves can be solenoid valves, and one of the control valves can be a normally open solenoid valve, while the other control valve can be a normally closed solenoid valve.

In a favorable embodiment of the vehicle steering system of the invention, the safety valves include an annular chamber and a piston chamber, with the annular chamber being connectable to the pressure conduit of the pressure source and the piston chamber being connectable to a return conduit.

In an improvement of the invention, pressure sensors are provided, which send an output signal to an electronic control unit for monitoring the proper functioning of the vehicle steering system. Advantageously, the electronic control unit can be designed in such a manner that it produces a switch-off signal for the vehicle steering system in a case of malfunction.

One embodiment of the invention is illustrated in the drawings. Like or corresponding parts have been designated by identical reference numerals in the different Figures of the drawings.

In the accompanying drawings:

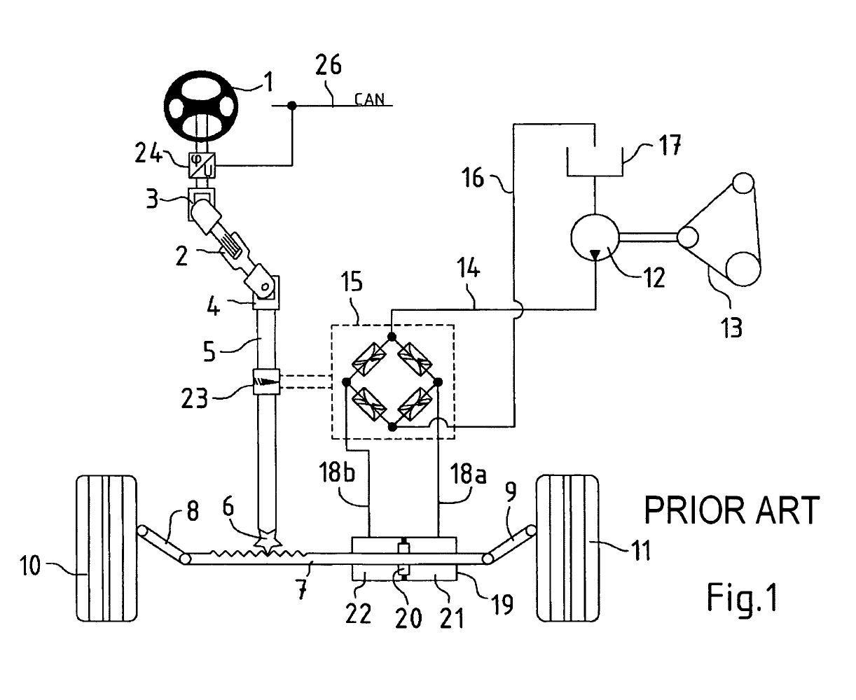

FIG. 1 is a basic diagram of the overall system of a vehicle steering system according to the state of the art;

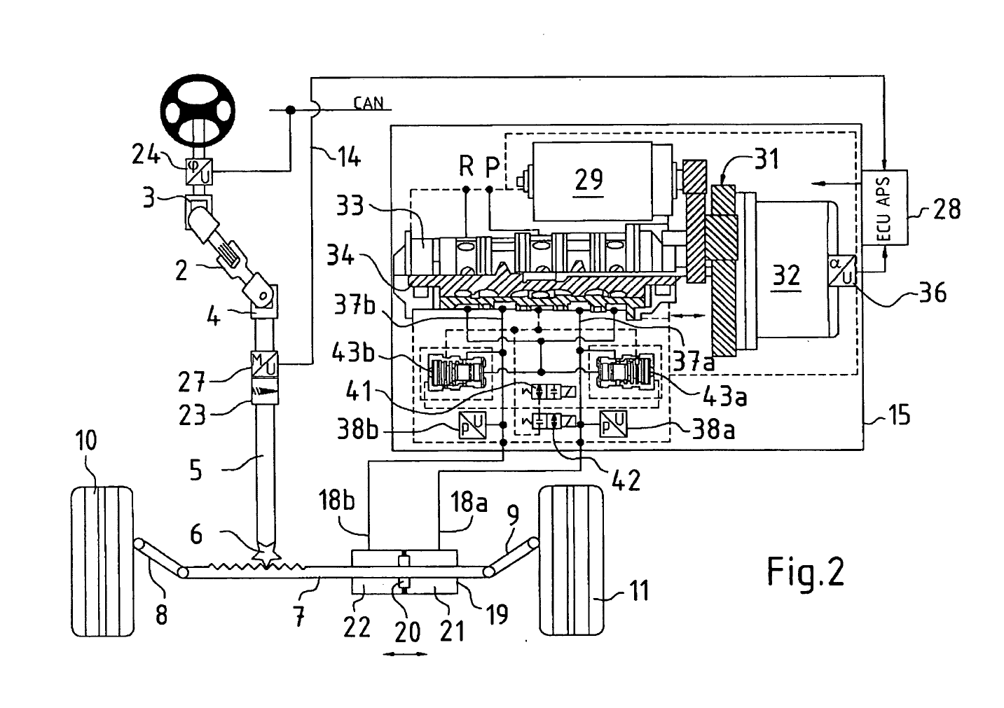

FIG. 2 shows a vehicle steering system of the invention;

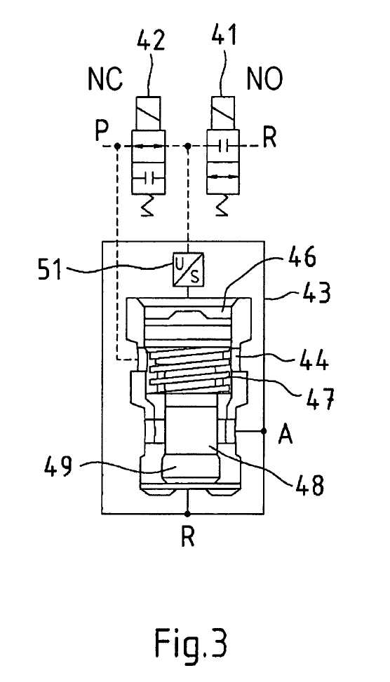

FIG. 3 shows the safety valve of the vehicle steering system of the invention of FIG. 2 in greater detail; and

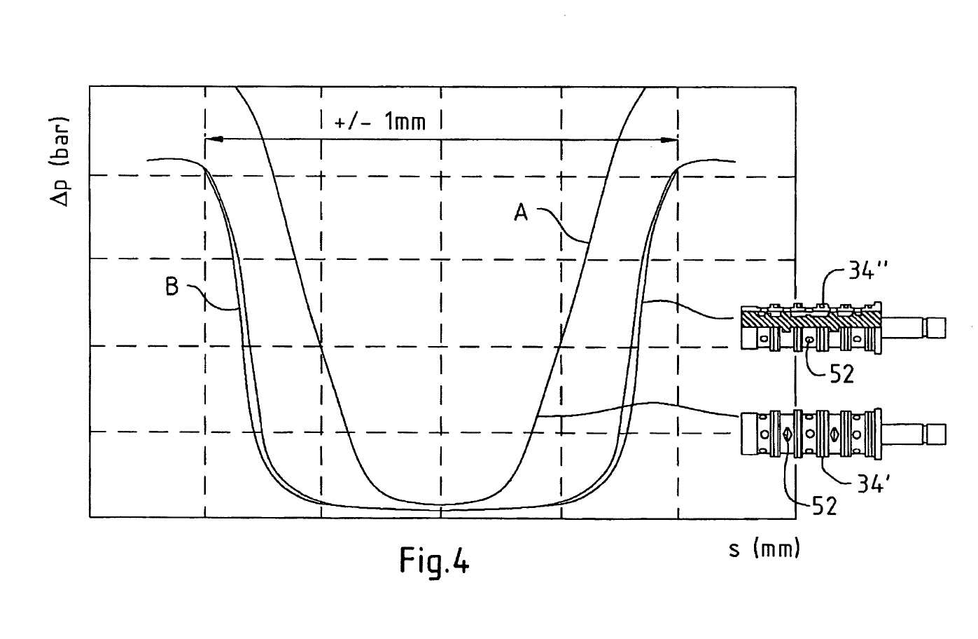

FIG. 4 shows characteristic curves of different embodiments of the steering valve of FIG. 2.

FIG. 1 shows a basic diagram of a known vehicle steering system. The steering system illustrated in FIG. 1 comprises a steering wheel 1 and a steering column 2, which is connected to the steering wheel 1 and has two universal joints 3, 4. The steering column 2 is connected to a steering wheel shaft 5 or forms part of the steering wheel shaft 5. The steering wheel shaft 5 drives a steering gear 6, converting the rotation of the steering wheel shaft 5 into a translational motion of a steering rod 7. In FIG. 1, the steering rod 7 is configured as toothed rack 7 that operates the tie rods 8, 9 arranged at the steering rod 7. The actuation of the tie rods 8, 9 causes wheels 10, 11 to deviate in order to steer the direction of travel of the vehicle. In the rack-and-pinion steering system (as shown herein), hydraulic aid is realized by means of a hydraulic pump 12 that is driven by means of the driving motor of the vehicle. Pump 12 is driven by way of a belt drive 13 in the illustrated embodiment. Of course, other appropriate driving means are also feasible in order to realize the invention at issue. Hydraulic pump 12 produces pressure in a hydraulic fluid, which is fed through a conduit 14 to a teering valve 15. The pressure fluid can flow back into a supply reservoir 17 by way of a return conduit 16. The steering valve 15 configured as a directional control valve is connected to a hydraulic steering cylinder 19 by way of two hydraulic conduits 18a, 18b. A piston 20 subdivides the steering cylinder 19 into two cylinder chambers 21, 22. Piston 20 is immovably seated on the steering rod 7 so that the piston 20 can exert a force directly to the steering rod 7 when excess pressure is applied to one of the two cylinder chambers 21, 22.

A torsion rod 23, which is mechanically coupled with the steering valve 15, is arranged between the second universal joint 4 and the steering gear 6. Depending on the steering torque exerted at the steering wheel 1, the steering valve 15 is actuated correspondingly to the effect that the rate of steering boost is the greater the higher the steering torque is. Further, an angle sensor 24 is arranged between the steering wheel 1 and the first universal joint 3, which measures the angle of rotation and outputs a corresponding output signal to a vehicle bus (CAN). The vehicle bus transmits the signal representative of the steering angle e.g. to a driving stability control system (ESP), which is not illustrated in FIG. 1.

The angle sensor 24 e.g. concerns the angle sensor, which is typically used in ESP systems in order to find out the driver's specification of the steering angle, which is then taken to determine a desired performance of the vehicle.

In the straight-ahead position of the steering wheel, a constant oil flow propagates through the steering valve 15 being in its neutral position (open center) and flows back through the return conduit 16. In this case, the pressure in the two cylinder chambers 21, 22 of the steering cylinder 19 is of equal rate. There is no steering boost.

When the steering wheel 1 is turned, the torsion rod 23 and the steering gear 6 cause displacement of the toothed rack 7. The pressure of the pressure fluid supports the movement of the piston 20. The steering valve 15 causes pressure fluid to flow from one chamber into the other chamber so that hydraulic assistance is imparted to the steering operation.

FIG. 2 exhibits a schematic view of an embodiment of the vehicle steering system of the invention. Arranged at the torsion rod 23 is a torque sensor 27 in the steering column 2, by means of which a hand moment of the driver is measured. The torque sensor 27 emits an output signal, which represents the magnitude of the hand moment of the driver, and sends this output quantity to an electronic control unit 28 of the vehicle steering system. The electronic control unit 28 controls the steering valve 15. A basic difference between the vehicle steering system of FIG. 1 known from the state of the art and the invention at issue can be seen in the circumstance that the steering valve 15 is uncoupled mechanically from the steering column 2 in the invention.

The steering valve 15 is a slide valve, which is configured as an electromotively driven servo valve and is functioning as a hydraulic full bridge. The steering valve 15 determines, on which one of the two cylinder chambers 21, 22 the hydraulic fluid that is supplied by the pump 12 will act, and determines the magnitude of the pressure. The magnitude of the pressure, or more specifically, the magnitude of the differential pressure between the cylinder chambers 21, 22, in turn fixes the rate of the steering boost.

The servo drive of the slide valve comprises an electric motor 29, which is coupled to a spur-gear system 31. The spur-gear system 31 drives a spring-centered rotation-translation gear 32, which in turn moves a piston 34 to and fro that is displaceable in a control sleeve 33. A sensor 36 for determining the angle of rotation is arranged at the rotation-translation gear 32 in order to monitor the rotary position of the gear 32.

The electric motor 29 is a direct-current motor in the present embodiment. The sensor 36 for determining the angle of rotation sends an output signal to the electronic control unit 28. The output signal of the sensor 36 for determining the angle of rotation indicates the rotary position of the gear 32.

The spring-centering of the rotation-translation gear 32 is so designed that, with the electric motor 29 not energized, the rotation-translation gear 32 returns into its mechanical zero position. At the same time, the control piston 34 of the slide valve is moved back into its hydraulic zero position due to the mechanical coupling to the rotation-translation gear 32. A position of the control piston 34, in which the control piston 34 constitutes a hydraulic short-circuit between the cylinder chambers 21, 22, is referred to as hydraulic zero position. As a result, the same pressure prevails in the two working chambers 21, 22 of the steering cylinder 19, i.e. the differential pressure is zero.

A specific rotary position of the gear 32 definitely fixes the position of the control piston 34 in the control sleeve 33. For this reason, the output quantity of the sensor 36 for determining the angle of rotation is fed back to the electronic control unit 28 in order to provide a control loop for the position of the control piston 34. In addition to the sensor 36 for determining the angle of rotation, a distance sensor can be provided at the slide valve, establishing directly the position of the control piston 34 in the control sleeve 33. This additional distance sensor (not illustrated in FIG. 2) renders it possible to obtain a higher degree of safety.

Each one hydraulic port 37a, 37b of the steering valve 15 connects to one of the two cylinder chambers 21, 22 of the working cylinder 19 by way of the hydraulic conduits 18a, 18b.

In each conduit 18a, 18b, a pressure sensor 38a, 38b is arranged in order to monitor the pressure prevailing in the hydraulic conduits 18a, 18b. The pressure sensors 38a, 38b are used to control the requested steering boost (differential pressure) and to monitor the proper mode of functioning of the vehicle steering system. The output signals of the pressure sensors 38a, 38b are also sent to the electronic control unit 28 of the vehicle steering system, which triggers a trouble signal when the pressures measured leave allowed operating ranges. The signal conduits between the pressure sensors 38a, 38b and the electronic control unit 28 are, however, not shown in FIG. 2 for the sake of clarity.

As a second fall-back mode, electromagnetic control valves 41, 42 are provided in the hydraulic conduits 18a, 18b, which are able to establish for each cylinder chamber 21, 22 a switchable connection to an unpressurized return conduit R leading to a supply reservoir. The control valve 41 is open (normally open, NO) in the non-energized condition, while the control valve 42 remains closed (normally closed, NC).

In addition, each one hydraulically drivable seat valve 43a and 43b, respectively, is arranged in the hydraulic conduits 18a, 18b. The two seat valves 43a, 43b are driven by the control valves 41, 42 in such a manner that the two cylinder chambers 21, 22 of the steering cylinder 19 are hydraulically interconnected through the two seat valves 43a, 43b when the control valves 41, 42 are not energized. The cylinder chambers 21, 22 are simultaneously connected to the unpressurized return conduit R. Thus, the steering gear 6 and the toothed rack 7 can be moved mechanically. That means, the steerability of the vehicle is preserved even without steering boost.

The two seat valves 43a, 43b are driven with the aid of the pump pressure P. In FIG. 3, one of the two seat valves 43a, 43b is shown, being designated by reference numeral 43. FIG. 3 further illustrates the two control valves 41, 42 in their normal operating position, that means, in the energized condition. In the non-energized switch position of the control valves 41, 42, the annular chamber 44 is connected to the pump pressure P, while the piston chamber 46 is connected to the return conduit R. The differential piston 48 of the seat valve 43 opens due to the balancing of forces and by the action of the compression spring 47.

In the energized switch position of the control valves 41, 42, the annular chamber 44 and the piston chamber 46 is connected to the pump pressure through the now open NC valve 42. Simultaneously, the piston chamber 46 is now separated from return conduit R by way of the closed NO valve 41. The differential piston 48 closes due to the balancing of forces. Preferably, the valve seat is represented by a hydraulically sealing central valve 49 in this case.

Two pressure sensors 38a, 38b monitor the function of the two seat valves 43a, 43b. Optionally, the travel can also be determined by way of the differential piston 48 using an integrated distance sensor 51 or travel switch.

FIG. 4 illustrates a diagram, which represents the differential pressure between the two working chambers 21, 22 of the steering cylinder 19 as a function of the displacement of the control piston 34 in the steering valve 15. The steering valve 15 is illustrated in FIG. 4 in two embodiments by the control piston and the control sleeve 33, which are furnished with control windows 52. The steering valve forms a hydraulic full bridge with concealed control edges. The configuration of the control windows 52 in the control sleeve 33 allows achieving different functions of the differential pressure due to the displacement travel of the control piston 34. The displacement travel of the control piston 34 roughly amounts to +−1 mm. Curve A in FIG. 4 belongs to a control sleeve 34′, where the control windows 52 are rhombic. The concealed portion amounts to 0.7 mm. Curve B in FIG. 4 belongs to a control sleeve 34″ with circular control bores 52. The concealed portion amounts to 1 mm. Compared to curve A, curve B also allows noticing a small hysteresis. It becomes thus obvious that the design of the control windows 52 in the control sleeve 34 allows adapting the pressure boosting function to modifications of the hydraulic pump 12. In another embodiment of the invention, solenoid valves can be a substitute for the hydraulically driven seat valves 43a, 43b, whereby the control valves 41, 42 become unnecessary.

1.-12. (canceled)

13. A vehicle steering system for motor vehicles with a steering handle (1) operable by a driver and functionally connected to steerable vehicle wheels to effect a direction of driving, comprising a hydraulic steering cylinder (19) having two cylinder chambers (21,22) and two directions of effect, and a hydraulic pressure source (12) which applies hydraulic pressure to a steering valve (15), the steering valve controlling the magnitude of the hydraulic pressure conveyed to the steering cylinder (19) and determining the direction of effect of the steering cylinder (19), wherein the steering valve is an electromotively driven slide valve with a control slide (34) and a rotation-translation gear (32) designed to displace the control slide (34) in a translational way.

14. The vehicle steering system as claimed in claim 13, wherein the rotation-translation gear (32) is spring-centered and resets itself into its zero position in the absence of an external drive (26).

15. The vehicle steering system as claimed in claim 13, wherein the steering valve includes a control piston (34) and a control sleeve (33), which forms a hydraulic full bridge with concealed control edges.

16. The vehicle steering system as claimed in claim 15, wherein the control sleeve (33) of the steering valve exhibits control windows (52), which can be adapted to the delivery volume of the hydraulic pressure source (12).

17. The vehicle steering system as claimed in claim 13, wherein a valve (43a, 43b) establishes a hydraulic short-circuit between the cylinder chambers (21, 22) of the steering cylinder (19) in the event of current failure.

18. The vehicle steering system as claimed in claim 17, wherein the valve is a hydraulically controllable seat valve (43a, 43b), which is driven by the pressure of the pressure source (12) and a control valve (41, 42).

19. The vehicle steering system as claimed in claim 18, wherein two seat valves (43a, 43b) are provided, which connect respectively one of the cylinder chambers (21, 22) of the steering cylinder to an unpressurized supply reservoir (17) in terms of flow when current failure occurs.

20. The vehicle steering system as claimed in claim 18, wherein two control valves are provided and wherein one of the control valves is a normally open solenoid valve (41), while the other control valve is a normally closed solenoid valve (42).

21. The vehicle steering system as claimed in claim 18, wherein the seat valve (43a, 43b) includes an annular chamber (44) and a piston chamber (46), in that the annular chamber (44) is connectable to the pressure conduit (P) of the pressure source (12) and the piston chamber (46) is connectable to a return conduit (R).

22. The vehicle steering system as claimed in claim 13, wherein pressure sensors (38a, 38b) are provided, which send an output signal to an electronic control unit (28) for monitoring the proper functioning of the vehicle steering system.

23. The vehicle steering system as claimed in claim 22, wherein the electronic control unit (28) is designed in such a manner that it produces a switch-off signal for the vehicle steering system in a case of malfunction.

24. The vehicle steering system as claimed in claim 13, wherein pressure sensors (38a, 38b) are provided, which send an output signal to an electronic control unit (28) for controlling the steering boost.
